(19) United States
(12) Patent Application Publication
(10) Pub. No.: US 2013/0147919 A1
(43) Pub. Date: Jun. 13, 2013

(54) Multi-View Difraction Grating Imaging With Two-Dimensional Displacement Measurement For Three-Dimensional Deformation Or Profile Output

(71) Applicant: California Institute of Technology, (US)

(72) Inventors: Shuman Xia, Pasadena, CA (US); Alexandra Gdoutou, Wilmette, IL (US)

(73) Assignee: California Institute of Technology

(21) Appl. No.: 13/708,679

(22) Filed: Dec. 7, 2012

Related U.S. Application Data
(60) Provisional application No. 61/569,040, filed on Dec. 9, 2011.

(51) Int. Cl. H04N 13/02

(52) U.S. Cl. CPC H04N 13/0203
USPC 348/46

(57) ABSTRACT

Hardware and software methodology is described for three-dimensional imaging in connection with optical transmission grating used to achieve a plurality of views of an area or entirety of an object imaged with a single digital camera for recording and subsequent processing. Such processing produces three-dimensional data (in terms of element displacement and/or object profile) using a two-dimensional displacement measurement technique only.

### RELATED APPLICATIONS

This filing claims the benefit of U.S. Provisional Patent Application Ser. No. 61/569,040 filed Dec. 9, 2011, which is incorporated by reference herein in its entirety for all purposes.

### STATEMENT OF GOVERNMENTAL INTEREST

Portions of these inventions were made with government support under DE-FC52-08NA28613 (T-105387) awarded by the Department of Energy. The government has certain rights in the subject inventions.

### FIELD

This filing relates to Diffraction Assisted Image Correlation (DAIC) for three-dimensional deformation and/or profile measurement.

### BACKGROUND

Measurement of strains and displacements is critical for the characterization of materials and for the analysis and design of engineering components and structures. Conventional approaches for displacement measurements include extensometers, strain gages, and optical methods such as moirè, and holographic and speckle techniques. Digital Image Correlation (DIC) provides a full-field non-contact optical method for the accurate measurement of two-dimensional (2D) or three-dimensional (3D) displacements, and therefore strains, during deformation of materials, devices and structures over a wide range of length and time scales.

Known 2D DIC methods are based on the comparison of two high contrast speckle images: one obtained before deformation and the other obtained after deformation. A random speckle pattern placed on the surface of the specimen is monitored during deformation using a digital camera. A grayscale distribution of the specimen is used to identify the relative positions of the same region (subsets) before and after deformation. A correlation analysis between images in the two deformation subsets is carried out by searching for the region that has the highest grayscale correlation with the initial region. Once the subset of the deformed image is obtained, the corresponding displacement is calculated. The use of subsets rather than tracking the individual speckles enables sub-pixel resolution. DIC has been used in full-field measurement of displacements at the micro and nano scales from digital micrographs obtained from electron (SEM) and scanning probe (AFM) microscopy.

Another technique for obtaining full-field displacement measurements is referred to as the grid method. In this approach, the grid is usually in the form of lines, circles, dots or other shapes assembled in regular patterns. The grid is first applied to a specimen surface before conducting tests. Images of the grid are then obtained before and while the specimen is undergoing loading. By comparing the grid of a deformed specimen to that of the undeformed reference state, the displacements and strains which are developed in the specimen during the loading can be quantified. There is a variety of approaches used to perform the image analysis, such as spot centroid tracking, cross-grid tracking, the spectral method, and Fourier transformation of the grid patterns.

DIC and other displacement techniques typically require high resolution cameras to image the marker (e.g., speckle or grid pattern) distribution of the specimen surface during deformation. For measurement by a 2D displacement technique, a single camera is used for the measurement of in-plane deformations. For 3D imaging to obtain the three displacement components (including the out-of-plane displacement) of a deforming surface, two cameras viewing the specimen at different angles are usually used.

Also known as stereo imaging, such an approach can be applied to general profilometry (i.e., measuring the profile of an object to generate three-dimensional data output). However employed, a general limitation of the stereo 3D technique is that the acquisition of images at different angles results in shape distortion of the regions being interrogated. It is also necessary to employ a 3D algorithm to compute the displacements from the two images obtained from viewing the specimen at two different angles.

Recently, 3D measurements (employing DIC displacement measurements in particular) have been made with a single camera using various approaches including object magnification, multiple mirror arrays, object rotation, etc. Single camera systems may be beneficial because of space limitations and/or cost reduction in system setup. Single camera systems avoid dynamic measurements synchronization issues endemic to two-camera systems, but the noted examples introduce other complexities. Accordingly, a need remains for improved 3D imaging solutions (i.e., for displacement and/or profile measurement) suitable for single-camera and/or simplified multi-camera use.

### SUMMARY

The inventive embodiments include the subject devices and systems (e.g., including the exemplary optical hardware referenced herein and the addition of a computer processor and other ancillary/support electronics and various housing elements), and methods (including the hardware and software for carrying out the same).

Generally, a 2D displacement measurement approach has been developed for 3D displacement and/or object profile measurement. In the subject approach, a diffraction grating is placed between a test specimen (or subject or object) and one or more cameras, which are used to capture multiple images from different viewpoints and then to obtain apparent in-plane displacements. The true in-plane and out-of-plane displacements (and/or profile of the specimen) are obtained from the apparent in-plane displacements and the diffraction angle of the grating. Distortions in the images are minimal since the specimen itself is not viewed at an angle.

By utilizing a line grating to obtain multiple-angle views of a test specimen, the approach provides a simple yet effective solution to accurate 3D displacement and/or profile measurement with only a single camera and a 2D displacement measurement technique.

In contrast to known methods, no 3D correlation of data is used for determining displacements or profiles. Therefore computational effort is significantly reduced. Moreover, the subject hardware approach (for profile and/or displacement measurement) eliminates the need for stereoscopic imaging and/or the use of multiple mirrors, thus optionally resulting in a robust, compact, and cost-effective setup.

The approach may be used to make such measurement at small length scales. Such application is described in further detail in “Diffraction Assisted Image Correlation: A Novel Method for Measuring Three-Dimensional Deformation using Two-Dimensional Digital Image Correlation,” Experimental Mechanics, DOI 10.1007/s11340-012-9687-0, to the inventors hereof and published online Oct. 23, 2012, which publication is incorporated by reference herein in its entirety for all purposes. Larger-scale measurement and/or imaging (e.g., in terms of measuring object profile) is possible as well.

Accordingly, the approach can be implemented in optical microscope systems for profile and/or deformation characterization of micro (or nano)-scale objects, including MEMS devices, micro (or nano)-structured and composite materials, and biological tissues and cells. Other potential applications include local strain measurements in deforming materials at the micro (or grain)-structural scale under quasi-static and dynamic loading conditions. Further potential applications include profile measurement for large as well as small-scale objects and/or features in connection with any of bench top, portable, or hand-held systems.

### BRIEF DESCRIPTION OF THE DRAWINGS

The figures provided herein are diagrammatic and not necessarily drawn to scale, with some components and features exaggerated and/or abstracted for clarity. Variations from the embodiments pictured are contemplated. Accordingly, depiction of aspects and elements in the figures are not intended to limit the scope of the claims, except when explicitly stated as such.

FIG. 1 illustrates an example of 2-D Digital Image Correlation (2D DIC).

FIG. 2 illustrates an example of operation of the subject single-camera 3D system, with optional hardware.

FIG. 3A illustrates an example embodiment of the optical arrangement for 3D displacement measurement using a diffraction grating and a single camera; FIGS. 3B and 3C illustrate example effects of displacements of an object on the diffracted images.

FIG. 4A is a side view photograph of an example experimental optical setup for 3D DIC measurement; FIG. 4B is a close-up view photograph of the arrangement of the grating and the specimen.

FIG. 5 diagrammatically illustrates the FIGS. 4A and 4B hardware.

FIGS. 6A and 6B are views illustrating alternative 3D measurement system embodiments.

FIG. 7 is a photograph of an example 80 cm diffraction grating.

FIG. 8A illustrates an example system overview of a known 3D DIC approach employing two cameras; FIG. 8B shows images of a circular region of a test grid from the FIG. 8A camera setup.

FIG. 9A illustrates an example system overview of the subject 3D DIC approach; FIG. 9B shows images of a circular region of a test grid from the FIG. 9A camera setup.

FIGS. 10A and 10B are speckle pattern photographs of a test membrane obtained with beam splitter grating before and after pressure deformation of a membrane, respectively. FIGS. 11A and 11B show in-plane negative first order (U⁻¹, V⁻¹) and FIGS. 11C and 11D show positive first order (U⁺¹, V⁻¹) displacements obtained using 2D DIC between the speckle images. FIGS. 12A-12C show contours of the in-plane (x,y) and out-of-plane (z) displacements of the pressurized membrane, respectively.

FIGS. 13A and 13B are speckle pattern photographs of the membrane for zeroth (right) and negative first (left) diffraction orders obtained with a blazing grating before and after pressure deformation, respectively. FIGS. 14A-14C show contours of the in-plane (x,y) and out-of-plane (z) displacements of the pressurized membrane, respectively.

FIGS. 15A and 15B are speckle pattern photographs of the negative first and zeroth diffraction orders, respectively, obtained with the beam splitter grating in imaging the head of a BARBIE doll.

FIG. 16 is a contour plot of the imaged subject.

FIG. 17 shows plots of profile mapping a cylindrical test surface (left), a conical test surface (middle) and a stepped test surface (right).

FIG. 18 shows plots of error measurement in association with the same.

FIG. 19 is an example embodiment of a software process flow chart.

### DETAILED DESCRIPTION

Various example embodiments are described below. Reference is made to these examples in a non-limiting sense. They are provided to illustrate more broadly applicable aspects of inventive aspects. Various changes may be made to the embodiments described and equivalents may be substituted without departing from their true spirit and scope. In addition, many modifications may be made to adapt a particular situation, material, composition of matter, process, process act(s) or step(s) to the objective(s), spirit or scope of the claims made herein.

The subject measurement techniques generally leverage two concepts: (i) use of a dispersive element (e.g., a diffraction grating) to provide undistorted images with different diffraction that can be used for comparison/correlation; (ii) out-of-plane displacement of the object being converted into in-plane displacements of the positive first and negative first (+/−1) order images by the diffraction grating. The undistorted images together with the information about all three components of displacements encoded in the in-plane displacements contained in the images enable the use of 2D DIC algorithms or other displacement measurement techniques (e.g., as referenced above) to extract the full 3D displacement field. For displacement measurement, images from the same order are compared via 2D DIC or otherwise. Then net displacements are determined algebraically by relating zeroth (0) order to either one +/−1 order or +/−1 order against each other through geometric relation. For profile measurement, images of different orders are compared (i.e., +/−1 against each other or 0 against either +/−1) via 2D DIC. Then, a net profile is determined, again algebraically through geometric relation.

In the case of displacement measurement, speckling or another affixed/permanent (e.g., laser or chemical etching) marker/patterning strategy for the target is required to facilitate correlation. For profile measurement, the same or a projected (e.g., by laser, etc.) marker/patterning may be employed. Per above, speckling will be desired for the DIC examples, otherwise a regular marker pattern may be employed.

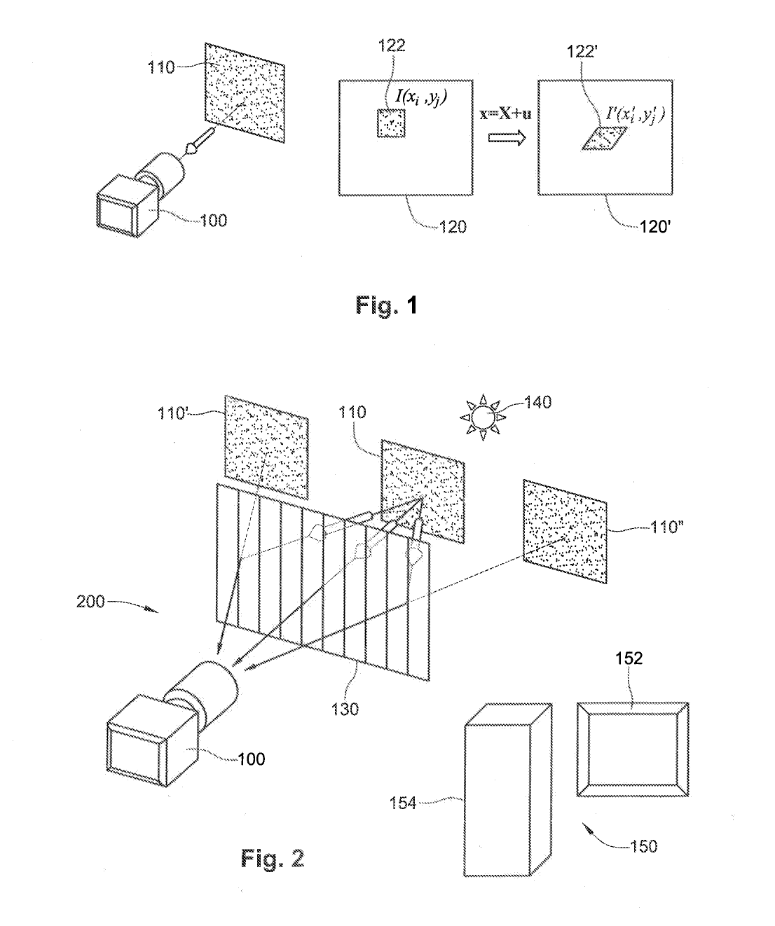

In any case, FIG. 1 illustrates the principle of 2-D Digital Image Correlation (2D DIC) where the 2D displacement of a subset is obtained by minimizing a cross-correlation function. Here, a camera 100 captures images of a speckled target/specimen 110 (such speckling maybe provided by an applied carbon, contrast spray, etc). A first image 120 (with a subset 122 shown) is compared to a second image 120′ (with a corresponding subset 122′) shown. Comparison of the subsets determines (for the selected area) how the object has changed shape/deformed.

FIG. 2 illustrates the principle of operation of the subject approach in which a diffraction grating is employed to capture a plurality of images from different angles and then analyze them using a 2D DIC or another two-dimensional displacement measurement approach. The angular differences between the views allow for dynamic measurement of changes in the shape of an object, in static profile measurement or may be applied otherwise.

In FIG. 2, system 200 operates with a camera 100 viewing the region of interest (i.e., target/subject/object 110) through a transmission diffraction line grating 130. When the grating is placed in front of the specimen multiple views of the specimen (110′, 110″) are obtained corresponding to different diffraction orders. As discussed further below, the type of grating is interchangeable between beam splitter grating (as shown), blazing grating and/or other types of diffraction grating. Some resulting system variations are described below. Per above, these embodiments are described in a non-limiting sense, as are the referenced DIC techniques.

In any case, as shown in FIG. 2 with a beam splitter grating 130, three images are produced corresponding to −1, 0 and +1 orders of the diffraction grating. Illumination with monochromatic light (as an optional back-lighting illumination source 140) is advantageous for producing “clean” (i.e., low noise signal, low chromatic dispersion) speckle images. Selection of an optimal light wavelength may be based on the spectral responsivity of the imaging system. Notably, the “light” may be visible light or represent RF radiation wavelength(s) outside the viable range of the human eye.

System 200 also optionally also includes a computer system 150 with (optional) display 152 and a processor (e.g., within computer housing/box 154) running purpose-appropriate software such as further described in the Examples below. A digital sensor (e.g., CMOS or CCD) within camera 100 captures image data. The recorded data may be processed by microprocessor within the camera and/or by computer 154. In the latter case, the data may be transmitted from the camera sensor and associated electronics by wired connection (not shown) or wireless communication using any of a variety of protocols.

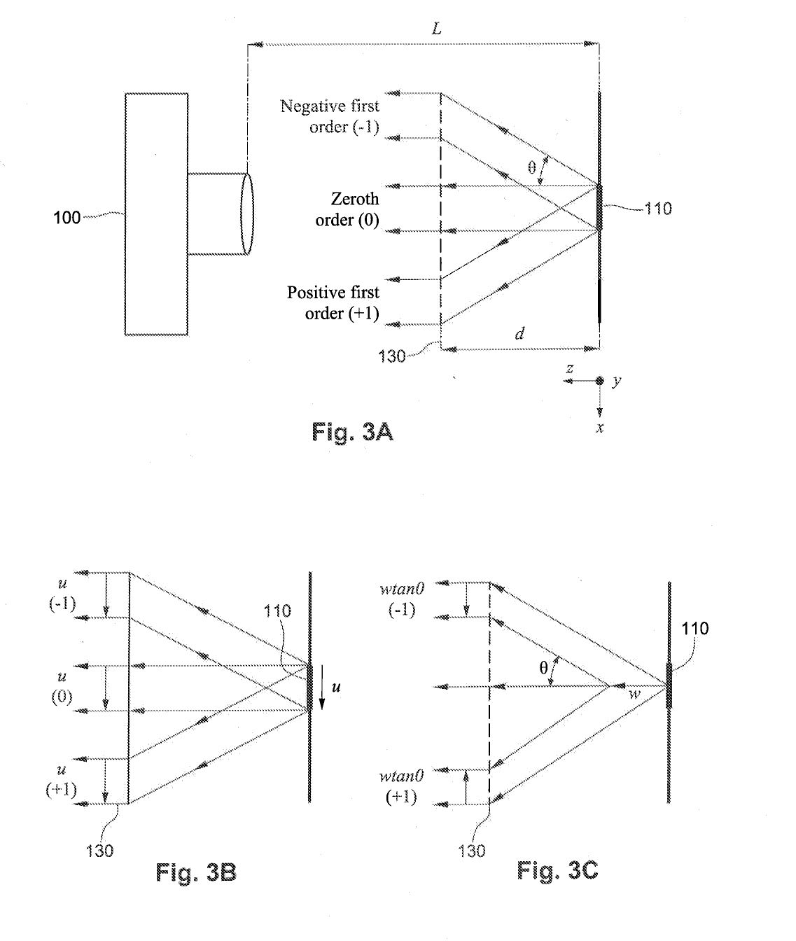

FIG. 3A illustrates the optical arrangement for 3D displacement measurement using a beam splitter diffraction grating 130 and a single camera 100. An x-y axis defines the in-plane coordinates of the object 110 and z defines the out-of-plane direction as shown. The focus here is on the 0 and +/−1 order images (labeled as such in the figure) that correspond to the direct transmission and the first-order diffraction of the light, respectively. The +/−1 order images are formed at angles (+/−θ) determined from the diffraction grating equation,

$$sin θ = \frac{λ}{p} , \qquad ( 1 )$$

where λ is the wavelength of the monochromatic light source and p is the pitch of the grating (1/Line Density). The minimum distance between the specimen and the grating (d) should be such that there is no overlap between neighboring diffracted images on the image plane. This distance (d) can be related to the size of the region of interest (h) on the subject through the simple geometrical relation,

$$d = \frac{h}{tan θ} . \qquad ( 2 )$$

FIGS. 3B and 3C illustrate the effect of displacements in/of the object 110 on the diffracted images. In FIG. 3B, the in-plane displacements are preserved in all diffracted images and are illustrated for the component in the x-direction, namely u. In FIG. 3C, the out-of-plane displacement, w is transformed into an in-plane displacement in the +/−1 order diffracted images, while it has no effect on the 0 order image.

As shown in FIG. 3B, an increment of in-plane displacement at a point causes all the diffracted beams to be displaced equally by the same amount in the in-plane, for displacement u in the x-direction. However, as illustrated in FIG. 3C, when there is an out of plane displacement (w) of a point in the z-direction, the displacement is converted by the diffraction grating to an in-plane displacement. The out-of-plane displacement is converted to an in-plane displacement (wₚ) of magnitude,

wₚw tan θ. (3)

Note that the out-of-plane displacement is projected in the opposite directions for the in-plane displacement in the +1 and −1 order diffracted images.

The net in-plane (x-y) displacements U and V of the +1 order images are the superposition of the in-plane displacements, u and v, and the contribution from the out-of-plane displacement (Eq. (3)), w. The net displacements are determined using conventional 2D DIC by correlating images from the same order of the diffraction (i.e., correlate images obtained from +1 diffraction order before and after deformation and similarly for −1 diffraction order images). The superposition of displacements is used to obtain a three-dimensional displacement field using the two-dimensional net in-plane (x, y) displacement fields corresponding to the +1 (U⁺¹, V⁺¹) and −1 (U⁻¹, V⁻¹) first-order diffracted images. Based on the geometrical construction shown in FIGS. 3B and 3C, the 3D deformation displacement fields (u,v,w) can be computed thusly:

$$u ( x , y ) = \frac{( {U}^{+ 1} ( x , y ) + {U}^{- 1} ( x , y ) )}{2} \\ v ( x , y ) = \frac{( {V}^{+ 1} ( x , y ) + {V}^{- 1} ( x , y ) )}{2} \\ w ( x , y ) = \frac{( {U}^{+ 1} ( x , y ) - {U}^{- 1} ( x , y ) )}{2 tan θ} \qquad ( 4 a , b , c )$$

Note that adding the net in-plane displacements from the +1 and −1 order diffracted images removes the contribution from the out-of-plane displacement (FIG. 3C), while subtracting them provides the contribution due to the out-of-plane displacement.

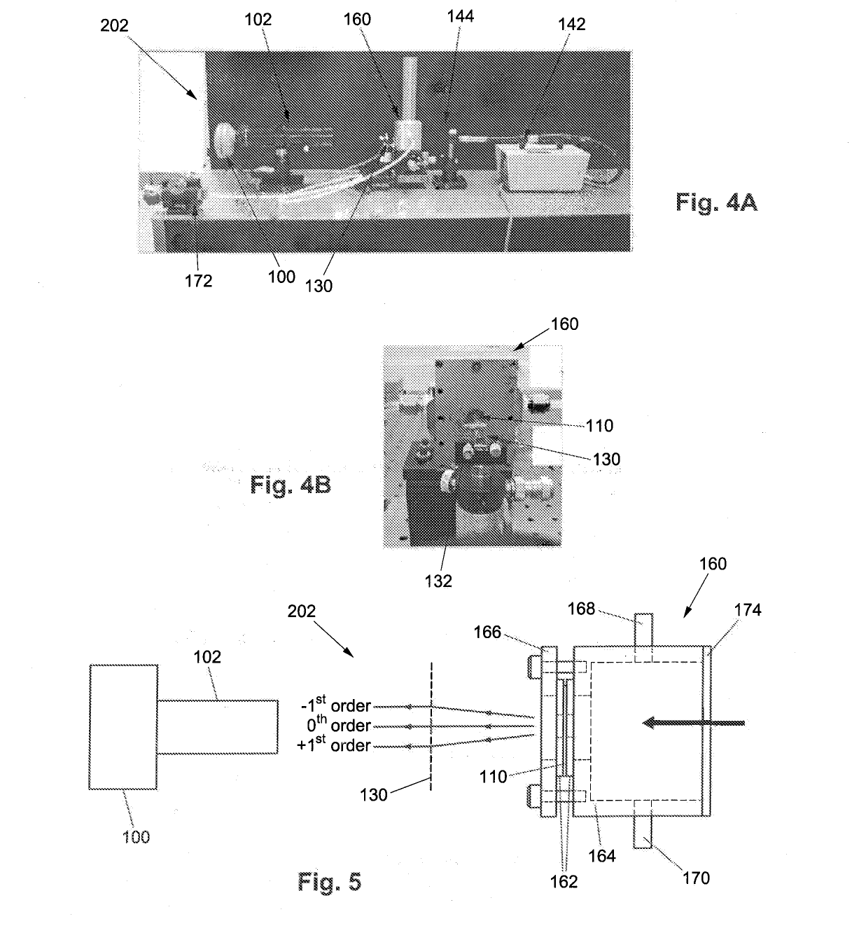

An experimental arrangement was constructed on an optical table for 3D DIC measurement allowing for demonstrating alternative embodiments (by changing grating type) of inventive aspects. FIGS. 4A and 4B are photographs of such hardware. FIG. 5 diagrammatically illustrates aspects of the same.

Accordingly, these figures variously show a system 202 with a digital camera 100 having a long-distance microscope lens 102 assembly imaging a speckle-coated membrane target 110 clamped to a pressure chamber 160 by plates 162 set between a pressure chamber body 164 and a face plate 166. The pressure chamber has a pressure sensor port 168 and a pump port 170. In the setup shown, a syringe pump 172 is used to supply pressure. The imaging is performed through a transmission grating 130 secured in a holder 132. A white light source 142 is filtered to a selected wavelength by a band bass optical filter 144 and passes into the pressure chamber through a transparent glass backing 174 (which action is indicated by the arrow) and then through target membrane 110 to camera 100 for recording and/or processing.

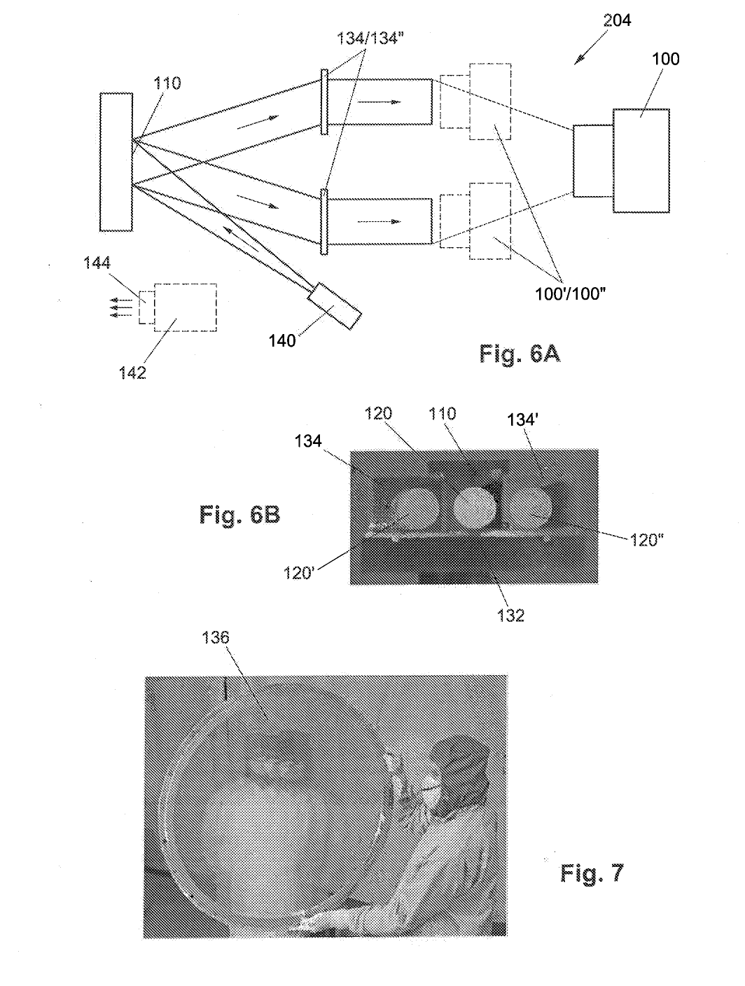

FIGS. 6A and 6B are views of an alternative system 204 setup. In FIG. 6A, a light source 140 (e.g., a white light source) or an alternative laser 142 with a diffuser 144 providing columnated light) is positioned to reflect light off a speckled target zone 110. The light passes through blazing diffraction grating element(s) 134, 134′ secured in a holder 132. The light is collected by a single camera 100 or multiple cameras 1007100″.

The advantages of using a single camera have been treated above. Multiple-camera use can, however, advantageously increase available sensor area/resolution. Moreover, in the subject system, because the target images 120, 120′ and 120″ can be taken axially/head-on with no distortion (i.e., without an angular setup), the disadvantages expressed regarding multiple camera stereo-based systems are avoided.

In any case, as shown in FIG. 6B, the optical setup in FIG. 6A enables recording/capturing an central unmodified image 120 and one or two angularly displaced diffracted images 120′, 120″ through their own, respective, grating element. The processing employed may compare the central image against one or both of the side images, or it may compare the side images against one another to resolve 3D data therefrom.

FIG. 7 is a photograph of an 80 cm diameter, 32.5-meter focal-length diffracted optical element 136. The diffraction pattern was printed and etched onto an 18-micron-thick membrane by Lawrence Livermore National Laboratory. As evident from the view of the technician behind this large-scale grating, optical element 136 operates as a beam-splitter grating, producing three images (central 0 order and +/−1 order side-images). Such a structure or others that may readily be constructed by those with skill in the art open the possibility for application of the system systems in a wide range of larger-scale imaging projects, whether focused on material deformation and/or object profilometry.

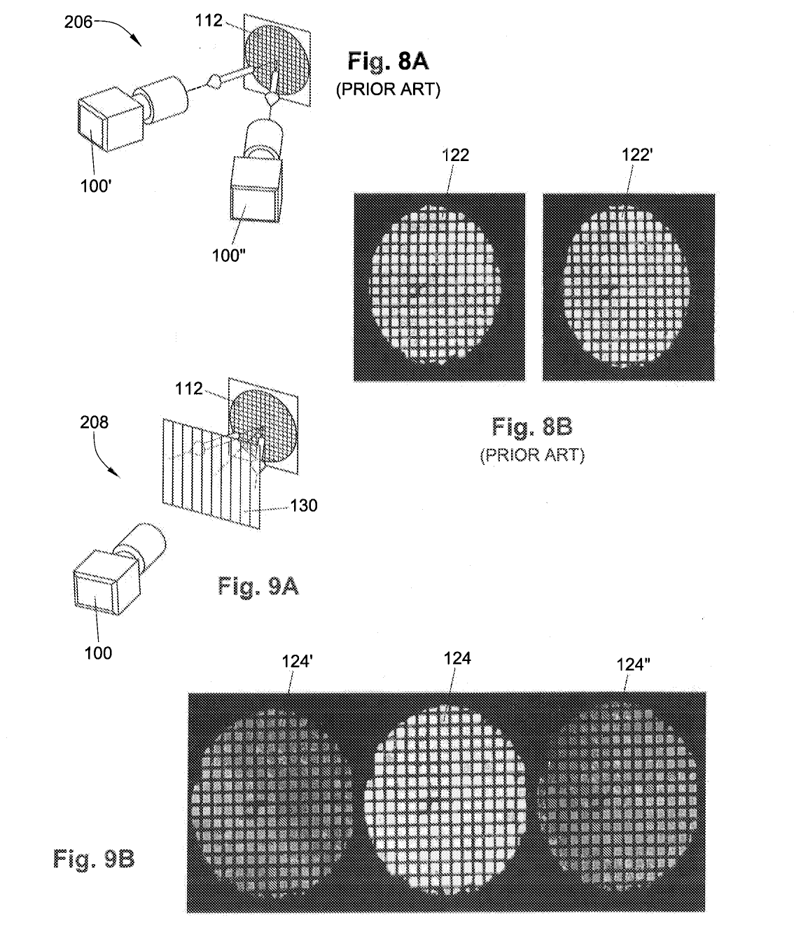

In contrast, FIG. 8A provides an overview of a known 3D DIC system 206 employing two cameras 100′, 100″. FIG. 8B shows captured views 122, 122′ of a circular region (in this case 1.9 mm diameter of a TEM test grid 112) from the two different camera angles (+/−40 degrees). Such a system may be regarded as a “traditional” or “classic” stereo 3D DIC system. Aside from presenting other non-optimal physical factor issues (some noted above), image processing requirements are relatively higher than those of the subject embodiments. Specifically, the classic/traditional system must account for the notable distortion of the captured images due to the perspective nature of the view from each camera.

With system 208 of FIG. 9A, test images of the same TEM target grid 112 were obtained as shown in FIG. 9B. As such, the single camera 100 and the beam splitter transmission diffraction grating 130 produced three undistorted face views 124, 124′ and 124″ of the grid corresponding to 0, −1 and +1 diffraction orders, respectively.

Use of the grating in place of stereoscopic images (by viewing the region of interest at two different angles or using mirrors) substantially or altogether eliminates distortion of the images and uncertainties associated with calibrating the angles in the geometrical arrangement. Instead, the incident light rays from the specimens on the grating are processed through diffraction to create multiple images and results in a compact arrangement in comparison to the above-referenced 3D DIC techniques developed to date. Since the out-of-plane displacements are encoded in the in-plane displacements, the subject approach eliminates the need for a 3D DIC algorithm. The full 3D displacement can be obtained with 2D DIC algorithms with any combination of two or more diffracted views and/or a non-diffracted (i.e., native or original) view, which is relatively easier to implement and less computationally intensive. Various examples of such use are provided below.

### Examples IA and IB

The subject 3D DIC technique is illustrated in a first set of examples using two different types of gratings in connection with the hardware otherwise described above in connecting with FIGS. 4A/4B and 5. The gratings used in experiments convert out-of-plane displacement into in-plane displacement, which is encoded in two (blazing grating) or three (beam splitter grating) undistorted face views of the specimen. With the blazing grating, two images of the zeroth (0th) and first (1st) diffraction order were obtained. From the beam splitter grating, three images of the negative first (−1), zeroth (0) and positive first (+1) were obtained. The images were processed using Vic-2D software (Correlated Solutions, Inc., W. Columbia, S.C.) to obtain net in-plane displacements (U,V) for each diffracted order. The data was exported into MATLAB and the true in-plane-displacements (u,v) and the out-of-plane displacement (w) were computed using Eq. (4 (a)-(c)), respectively.

In these examples, the subject 3D DIC technique is demonstrated by pressure bulge experiments on a thin polymeric membrane made of polydimethylsiloxane (PDMS). The elastomer and curing agent of PDMS (Sylgard 184, Dow Corning Company, Midland, Mich.) were mixed at a weight ratio of 10:1, and degassed in a vacuum chamber for 30 minutes to remove trapped air bubbles. The liquid PDMS premix was then spin-coated on a transparency film, followed by curing at 80 degrees C. for 1 hour. The cured thin membrane was peeled off from the transparency film and was cut to size for use in bulge test experiments. The membrane was covered using a brush, with fine graphite powder (3-5 μm in size) in order to create a random speckle pattern as well as the contrast which is required for DIC.

The membrane was clamped between two thin steel disks, which were in turn attached to an airtight pressure chamber. The membrane specimen was inflated by increasing the pressure inside the chamber with a syringe mounted on the optical table, and the pressure was monitored using a pressure sensor (GPS-BTA, Vernier, Beaverton, Oreg.). The membrane has a thickness of approximately 40 μm and a diameter of 1.9 mm for the inflated area. The pressure was increased from zero to 5 kPa or 6 kPa for inflating the membrane.

A light beam, filtered with a narrow band optical filter (632-634 nm bandpass), was directed at the back of the membrane for illumination. The light rays passing through the specimens and processed by the grating were collected by a long distance microscope lens (K2/S, Infinity Photo-Optical Company, Boulder, Colo.), and focused on the CMOS Camera with a 3.0 megapixel sensor and imaging speed of 12 frames per second (PL-E533, PixeLINK, Ottawa, Canada). A working distance of 152.4 mm between the sample and the camera lens was kept constant for each of the experiments. See the setup in FIGS. 4A/4B and 5

The light transmitted/reflected from the specimen passes through a diffraction grating. As stated above, two types of gratings were used in the experiments: the first grating was a beam splitter grating of 110 lines/mm groove density (NT46-073, Edmund Optics, Barrington, N.J.), while the second grating was a blazing grating of 300 lines/mm groove density (NT49-575, Edmund Optics, Barrington, N.J.). The value of 0 (angle of the first-order diffracted beams) calculated using Eq. (1) for the beam splitter grating was 3.99 degrees and for the blazing grating is 10.98 degrees. Equation (2) was used to compute the distance between the sample and the grating, d (FIG. 3A). The value of d chosen for the beam splitter grating was 29.3 mm and for the blazing grating was 10.4 mm to insure that the diffracted images were not overlapping.

The choice of groove density of the grating (at a given wavelength, λ) will dictate the diffraction angle and hence the images that may be collected by the camera. Generally, the higher the groove density, the wider the separation of images (larger θ), in which case only two images corresponding to the zeroth and either positive or negative first order diffraction are collected and recorded by the camera. While the examples were configured to avoid image overlap, it is not necessary that image overlap be avoided in all embodiments.

### Example IA

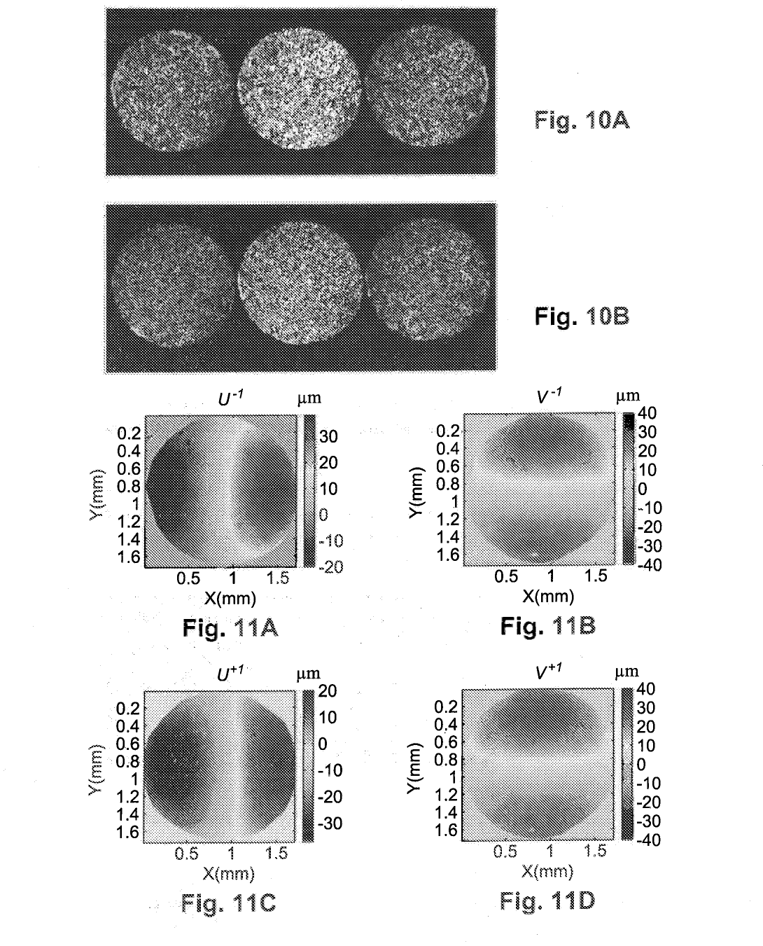

A first set of experiments used images collected with the beam splitter. As referenced above, this type of grating provides three side-by-side images of the membrane corresponding to the −1, 0 and +1 orders of diffraction. During the experiments, the PDMS membrane was inflated up to a pressure of approximately 5 kPa. The three images of the speckle patterns of the circular membrane captured before and after pressurization are shown in FIGS. 10A and 10B for −1, 0 and +1 diffraction orders, respectively.

The two sets of three images (each of the speckle pattern corresponding to the −1, 0 and +1 diffraction images) were then correlated using Vic-2D between images obtained from the same order of diffraction, i.e., between +1 order images and between −1 order images (before and after deformation). This resulted in two sets of net full field in-plane displacements, U and V, namely, (U⁺¹, V⁺¹) and (U⁻¹, V⁻¹) as shown in FIGS. 11A-11D.

Note that these net displacement fields contain both in-plane and out-of-plane displacements of the membrane and do not exhibit symmetry. The components of the 3D deformation displacement field (u,v,w) are computed according to Eqs. (4) by using data from 2D DIC, and are shown (in μm scale) in FIGS. 12A-12C, respectively. The out-of plane displacement field shows axial symmetry corresponding to the deformation of a circular membrane and the in-plane displacements also show appropriate symmetries and anti-symmetries (e.g., u (v) is symmetric about the horizontal (vertical) axis and anti-symmetric about the vertical (horizontal) axis.

### Example IB

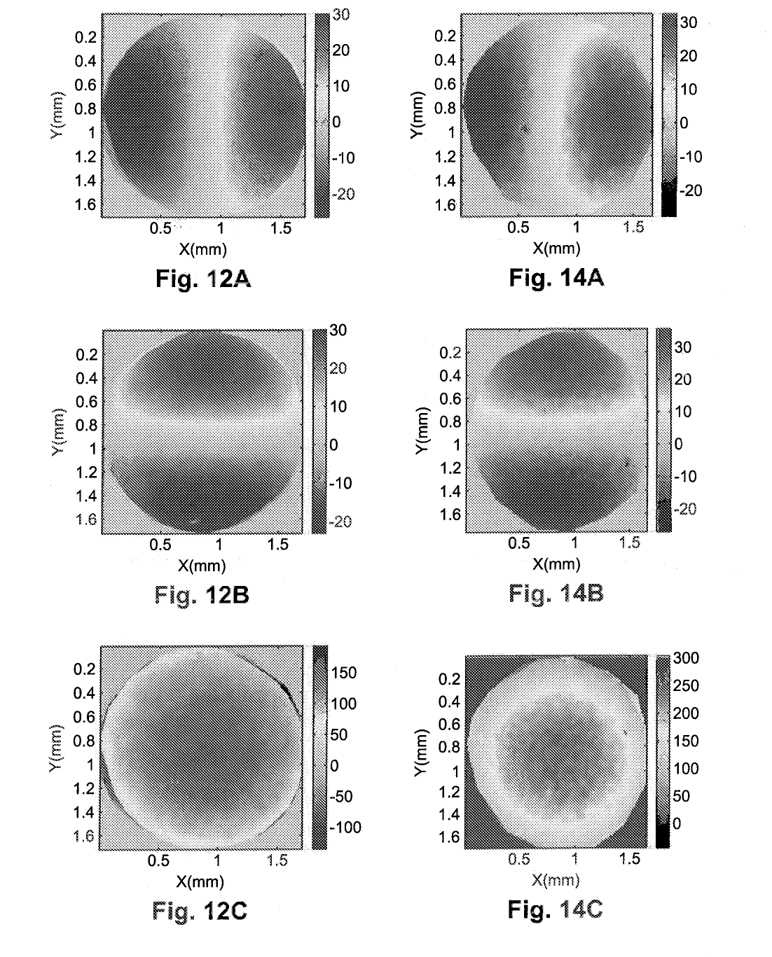

A second set of experiments collected images using the blazing grating, providing two side-by-side images of the membrane corresponding to the zeroth-order (0th) and the first-order (1st). Images were acquired before and after inflating the PDMS membrane to a pressure of 6 kPa. In this case, the two pair of images of the membrane were correlated, one obtained before deformation and another obtained after deformation, are shown in Fig. FIGS. 13A and 13B, respectively.

The zeroth and first order images were correlated using Vic-2D DIC software, and the data was imported into MATLAB to obtain the full-field 3D displacements. The 2D DIC provided the net in-plane displacements (U,V) in the x-y plane. It is noted that the image corresponding to the zeroth order image does not include the out-of-plane displacement while the first-order image contains the projected component (Eq. (3)) of the displacement field. Hence, the following equation can be deduced to obtain the out-of-plane displacement (w) of the membrane,

$$w ( x , y ) = \frac{( {U}^{0} ( x , y ) - {U}^{1} ( x , y ) )}{tan θ} \qquad ( 5 )$$

where U⁰ represents the displacement corresponding to the 0 order images and U¹ represents the displacement of the +1 images obtained performing 2D DIC using Vic-2D. The three components of displacements (u,v,w) in the x-y plane are were calculated as shown in FIGS. 14A-14C, respectively. The out of plane displacement of the membrane seen in FIG. 14C have axi-symmetry comprable to that of FIG. 12C of Example 1, above.

### Example II

In this example, 3D surface profile measurement of an object was demonstrated. A BARBIE doll head was mounted on a stand and a black background is placed behind the head. The head was spray painted with white paint to achieve a neutral colored surface, and then it is sprayed with black paint to achieve the speckle pattern. However, as noted above, a speckled or other marker pattern could have been projected (e.g., by laser 190) onto the surface to be measured.

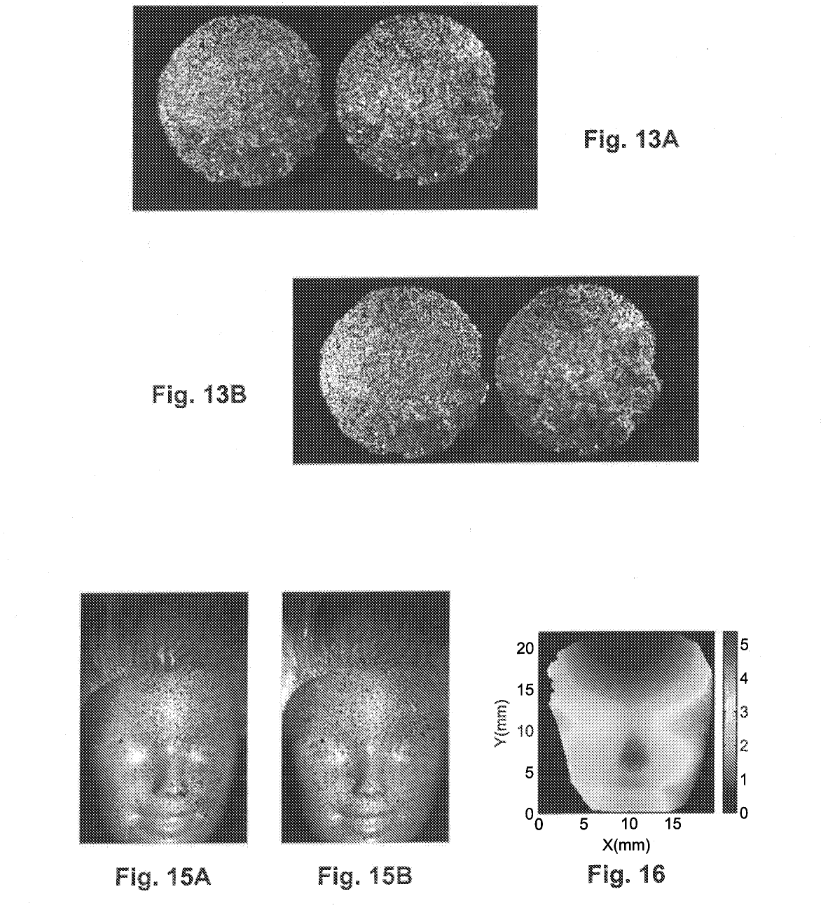

Measurement was performed using a single camera and a beam splitter grating of 300 line/mm groove density placed in front of the camera. The method compares two speckle images, corresponding to the −1 and 0 order diffraction. With a light beam filtered by a narrow band optical filter (632-634 nm bandpass) pointed to the front of a BARBIE head for illumination, two speckle images were captured as shown in FIGS. 15A and 15B. The images were acquired are of different exposure times to mitigate differences in lighting and make the images more easily/accurately comparable via 2D DIC. The angled image at left corresponds to the −1 order diffraction and the head-on view at right to the 0-order diffraction.

The distribution of apparent in-plane displacement, u(x,y), between the two images was obtained using 2D DIC, and converted to the distribution of out-of-plane profile, h(x,y), using the equation using the equation:

h(x,y)=u(x,y)/tan(θ) (6)

(related to Eq. (2) above) where θ is the first-order diffraction angle of the grating per Eq. (1).

FIG. 13 is a plot contour plot of the imaged subject. It demonstrates (even with coarse preparation in terms of speckling or otherwise marking the surface) the potential of the approach in terms of object profile imaging.

### Example III

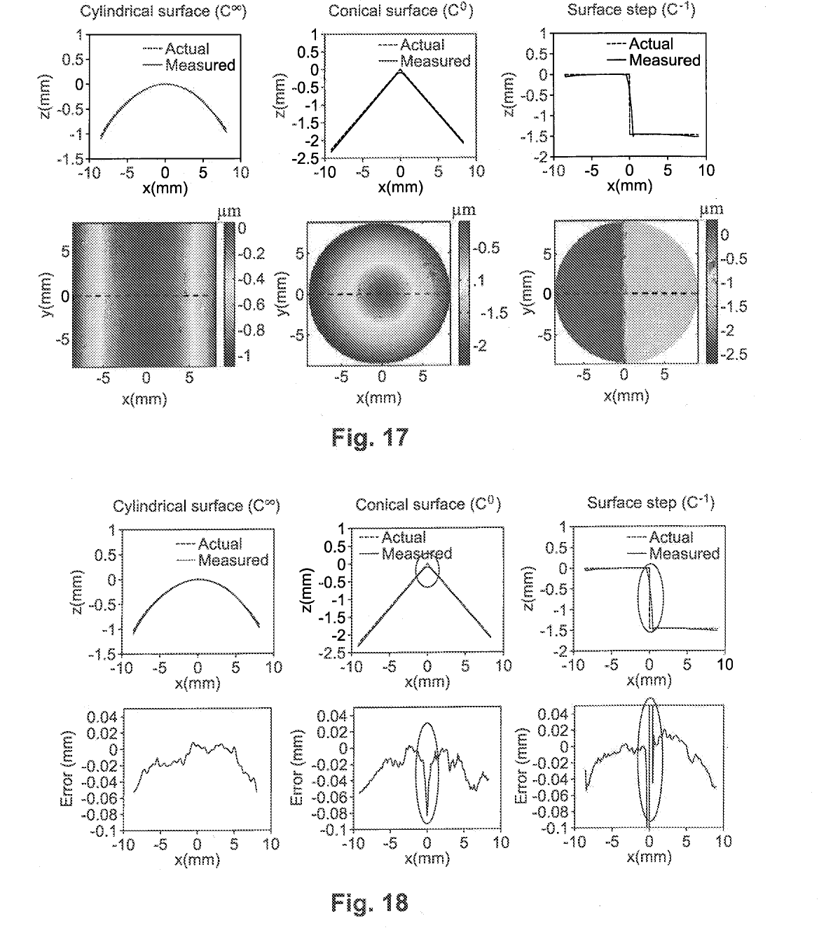

In a more analytical example (or set of examples), FIG. 17 shows plots of 3D profile mapping of a cylindrical test surface (left), a conical test surface (middle) and a stepped test surface (right) employing the subject hardware and methods. In reference to FIG. 18, it can be seen that very good agreement between actual and measured geometry was demonstrated.

As such, profile/shape information is produced with little artifact except at or along regions of discontinuity. Various filter and/or data-smoothing techniques are commonly available to address any such “noise” in producing a useful output data set for various uses including STL files for any of a variety of rapid prototyping/milling techniques that can be applied to “copy” or re-create scanned geometry. Naturally, the same holds true with respect to conducting profilometry on other objects.

System Options

In addition to the several embodiments that been disclosed in detail above, still more are possible within the classes described and the inventors intend these to be encompassed within this Specification. This disclosure is intended to be exemplary, and the claims are intended to cover any modification or alternative which might be predictable to a person having ordinary skill in the art.

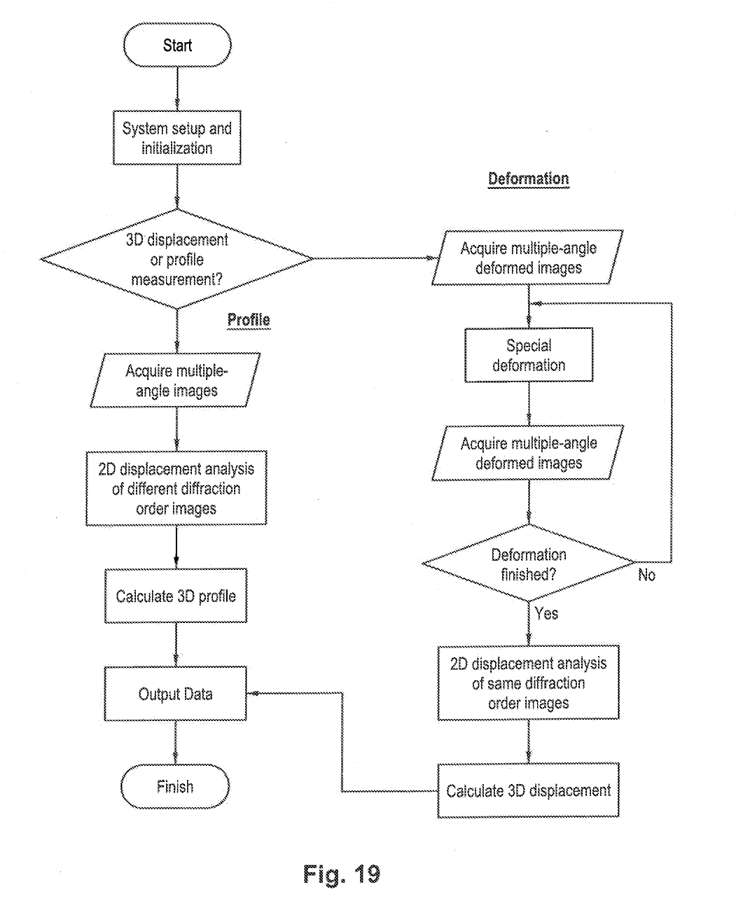

In this regard, FIG. 19 broadly presents the process flow for various embodiments hereof. The left-side brand describes activities associated with profilometry measurement and analysis, and the right-side branch describes activities associated with deformation measurement and analysis. Acts or steps common to each include system setup/initialization and data output in any of variety of electronic format(s). Further precedent, intermediate or subsequent acts and/or processes may be taken before and after “start” and “end” indicators of the subject processes.

Moreover, the various illustrative processes described in connection with the embodiments herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, DisplayPort, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein. The camera may be a digital camera of any type including those using CMOS, CCD or other digital image capture technology.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on, transmitted over or resulting analysis/calculation data output as one or more instructions, code or other information on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and BLU-RAY disc where disks usually reproduce data magnetically, while discs reproduce data optically with lasers. Combinations of the above should also be included within the scope of computer-readable media.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, it is contemplated that any optional feature of the embodiment variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of the claim language. All references cited are incorporated by reference in their entirety. Although the foregoing embodiments been described in detail for purposes of clarity of understanding, it is contemplated that certain modifications may be practiced within the scope of the appended claims. Accordingly,

We claim:

1. A method of three-dimensional imaging, comprising:
directing at least one camera at a diffraction grating positioned between the at least one camera and a target;
capturing light, with the at least one camera, of a patterned surface of the target in a plurality of images from different angles; and
analyzing images, with at least one processor, by a two-dimensional displacement measurement technique to determine three-dimensional data for the target.

2. The method of claim 1, wherein the plurality of images are captured without distortion.

3. The method of claim 1, further comprising passing light through the target for camera capture.

4. The method of claim 1, further comprising reflecting light from the target for camera capture.

5. The method of claim 1, wherein two images are analyzed.

6. The method of claim 5, wherein zero and first order images are compared.

7. The method of claim 6, wherein the first order images are selected from positive and negative first order images.

8. The method of claim 5, wherein the grating is blazing grating and the first order image is a positive first order image.

9. The method of claim 1, wherein three images are analyzed.

10. The method of claim 9, wherein the grating is beam splitter grating.

11. The method of claim 10, wherein negative first, zero and positive first order images are analyzed.

12. The method of claim 1, wherein the system includes only one camera.

13. The method of claim 1, wherein capturing light with the at least one camera further comprises passing the light through a long-distance microscope lens attached to the camera.

14. The method of claim 1, performed for dynamic material deformation analysis by comparing a plurality of same diffraction order images.

15. The method of claim 1, performed for static object profile measurement by comparing a plurality of different diffraction order images.

16. The method of claim 15, wherein the plurality of images are taken with different exposure times.

17. The method of claim 1, further comprising outputting the three dimensional data in a computer-readable format.

18. A computer readable medium having stored instructions thereon that, when executed, cause at least one processor to:
receive input signals corresponding to a plurality of undistorted patterned images of an object, taken from different angles;
calculate, using a two-dimensional displacement measurement technique, a three dimensional profile of the target; and
output an output signal corresponding to the three dimensional profile of the target.

19. The computer readable medium of claim 18, wherein the pattern is selected from a grid pattern and a speckled pattern.

20. A three-dimensional imaging system for a target comprising:
at least one camera including a lens and a digital sensor;
a diffraction grating positioned between the at least one camera and a target to provide a plurality of views of the target from different angles; and
a computer processor connected with the sensor for processing captured digital sensor information for producing three-dimensional data of the target.

21. The system of claim 20, wherein the system includes only one camera.

22. The system of claim 20, wherein the diffraction grating is positioned relative to the at least one camera to allow image capture of the views without distortion.

23. The system of claim 20, wherein the diffraction grating is positioned relative to the at least one camera to allow image capture of the views without overlap.

24. The system of claim 20, wherein the grating comprises beam splitter grating.

25. The system of claim 20, wherein the grating comprises blazing grating.

26. The system of claim 25, further comprising a lighting source.

27. The system of claim 26, wherein the lighting source is positioned to transmit light through the target for imaging.

28. The system of claim 26, wherein the lighting source is positioned to reflect light from the target for imaging.

29. The system of claim 20, further comprising the target.

30. The system of claim 29, wherein the target is speckled.
